(19) United States
(12) Patent Application Publication
(10) Pub. No.: US 2014/0287328 A1
(43) Pub. Date: Sep. 25, 2014

(54) METHOD FOR PRODUCING FUEL BATTERY, AND FUEL BATTERY AND ELECTRONIC DEVICE

(71) Applicant: Sony Corporation, Tokyo (JP)

(72) Inventors: Tsunetoshi Samukawa, Kanagawa (JP); Hideyuki Kumita, Kanagawa (JP); Taiki Sugiyama, Kanagawa (JP); Hiroki Mita, Kanagawa (JP); Takaaki Nakagawa, Kanagawa (JP); Ryuhei Matsumoto, Kanagawa (JP)

(21) Appl. No.: 14/352,871

(22) PCT Filed: Oct. 19, 2012
(86) PCT No.: PCT/JP2012/077120

§ 371 Date: Apr. 18, 2014

(30) Foreign Application Priority Data
Nov. 2, 2011 (JP) 2011-241196

(51) Int. Cl. H01M 4/88; H01M 4/90

(52) U.S. Cl. CPC H01M 4/8828; H01M 4/9008; H01M 4/8878
USPC 429/401; 427/115; 429/535

(57) ABSTRACT

Provided is a method for producing a fuel battery in which an oxidoreductase has been fixed as a catalyst on at least one electrode of a negative electrode or a positive electrode, including conducting at least a step of preparing an electrode pattern, in which an electrode material containing at least electroconductive particles is printed on the surface of a bendable non-electroconductive sheet, and a step of preparing a negative electrode and a positive electrode, in which a negative electrode and a positive electrode are made by printing a predetermined oxidoreductase on the electrode pattern prepared in the step of preparing an electrode pattern.

### TECHNICAL FIELD

The present technique relates to a method for producing a fuel battery. More specifically, the present technique relates to a method for producing a fuel battery in which an oxidoreductase has been fixed as a catalyst on at least one electrode of a negative electrode or a positive electrode, and to a fuel battery produced by using the production method and an electronic device using the fuel battery.

### BACKGROUND ART

Batteries can be roughly classified into chemical batteries and physical batteries, and as the chemical batteries, primary batteries such as manganese dry batteries, alkaline dry batteries, nickel-based primary batteries, lithium batteries, alkali button batteries, silver oxide batteries and air (zinc) batteries, secondary batteries such as nickel-cadmium batteries, nickel-hydrogen batteries, lithium ion batteries, lead storage batteries and alkali storage batteries, and fuel batteries such as biofuel batteries are present, and as the physical batteries, solar batteries and the like are present.

Chemical batteries that relate to the present technique will be explained below. A primary battery is a battery that contains reaction substances inside and generates an electric current by the chemical reaction of the reaction substances, and can be used until all of the reaction substances are consumed, and examples may include dry batteries and the like. A secondary battery is a battery that has reaction substances inside, wherein the reaction substances decrease by generating an electrical current, but a converse reaction occurs by charging and the generated substances return to the original reaction substances, whereby the battery can be repeatedly used, and examples may include batteries for automobiles, lithium ion batteries and the like.

Among these, a fuel battery in which an oxidoreductase has been fixed as a catalyst on at least one electrode of a negative electrode or a positive electrode (hereinafter referred to as a biofuel battery) can efficiently remove electrons from fuels that are difficult to be reacted by general industrial catalysts, such as glucose and ethanol, and thus gains attention as a next-generation fuel battery that has a high volume and is highly safe.

As an example of a biofuel battery, a reaction scheme of a biofuel battery using glucose as a fuel will be explained. In a biofuel battery using glucose as a fuel, an oxidation reaction of glucose (Glucose) at a negative electrode proceeds, and a reduction reaction of oxygen (O₂) in the air proceeds at a positive electrode. Furthermore, at the negative electrode, the electrons are transferred to glucose (Glucose), glucose dehydrogenase (Glucose Dehydrogenase), nicotine amide adenine dinucleotide (NAD⁺; Nicotinamide Adenine Dinucleotide), diaphorase (Diaphorase), a mediator and the electrode (carbon) in this order.

Meanwhile, such biofuel battery is generally produced by dissolving a group of enzymes that dissolve fuels, NAD⁺ (nicotine amide adeninedinucleotide) and a reduced form thereof (NADH), NADH dehydrogenase, a mediator and the like to give respective solutions, suitably adding the respective solutions or a solution mixed with one or more of the respective solutions to an electrode material, suitably mixing and thereafter drying the solution/solutions on the electrode, and further repeating these addition, mixing and drying process once or more to prepare an electrode (see Patent Document 1), and laminating a proton transmitter, a fuel feeding layer for feeding the fuel to the negative electrode, a gas-liquid separation film and the like onto the prepared electrode. This method is a very complex method.

Furthermore, in a conventional biofuel battery, a power generation unit can be designed to be thin and small, whereas a predetermined size was required for a fuel tank depending on the intended purpose. Therefore, a space for a fuel tank was required irrespective of the presence or absence of a fuel, which consequently put a brake on the miniaturization of biofuel batteries.

On the other hand, in secondary batteries and solar batteries, a method for producing an electrode using an inkjet printing system is used, from the viewpoint that the electrode can be produced to be thin and homogeneous, and flatly, and thus a pattern with a desired shape can be produced in an economical way.

For example, in Patent Document 2, a technique relating to an electrode composition for preparing an electrode by an inkjet printing system, which can be used for a secondary battery, which can form a pattern that is precise while having a predetermined surface tension, by using a solvent having a boiling point that is not relatively high to thereby suppress the generation of a phenomenon in which undried liquid droplets can be apart from a target point while being transferred by a high surface tension, or the undried liquid droplets transfer while binding to the other liquid droplets.

Furthermore, Patent Document 3 discloses a technique relating to a method for producing a solar battery having a selective emitter structure having a high photoelectric efficiency at low cost, by applying a diffusion agent having a high dopant concentration onto a light receiving surface of a silicon substrate by an inkjet process or offset printing depending on a site on which an electrode is to be formed to thereby form a high concentration film, then applying a diffusion agent having a lower dopant concentration than that of the diffusion agent that has been previously applied, on the entirety of the light receiving surface of the silicon substrate by spin coating, to thereby form a low concentration film superposed on a high concentration film; then conducting a heat treatment to thereby diffuse the dopants to form a high concentration emitter layer and a low concentration emitter layer, and to form an antireflective film having a low refractive index on the high concentration emitter layer by the metal compound contained in the diffusion agent and form an antireflective film having a high refractive index on the low concentration emitter layer; and then forming a light receiving surface electrode on the high concentration emitter layer.

These methods for producing a secondary battery or a solar battery have advantages that a thin and flat battery can be produced by using a printing technique such as an inkjet system, and the like. However, these secondary battery and solar battery contain harmful substances (hazardous substances) and environmental pollutants in the electrode active substances containing metals, electrolytic solutions, fuels to be used, and the like, and also contain rare elements, and thus it is necessary to conduct disposition, collection and the like after separating these batteries from other waste materials. This problem is not limited to secondary batteries and solar batteries, and a similar problem also resides in commercially available primary batteries and fuel batteries.

Meanwhile, in biofuel batteries, persons skilled in the art have not selected use of a printing technique until now, which may be due to that it is considered to be important to maintain the activity of an enzyme.

### CITATION LIST

### Patent Documents

### Patent Document 1: Japanese Patent Application Laid-Open No. 2006-127957

### Patent Document 2: Japanese Patent Application Laid-Open No. 2010-097946

### Patent Document 3: Japanese Patent Application Laid-Open No. 2010-109201

### SUMMARY OF THE INVENTION

### Problems to be Solved by the Invention

As mentioned above, the method for producing a biofuel battery is very complex. Furthermore, a fuel tank for a biofuel battery requires a predetermined size depending on the intended purpose. Therefore, commercially available biofuel batteries have predetermined sizes, shapes, performances and the like, and thus design modification such as miniaturization according to the intended purpose was not able to be easily conducted.

Furthermore, as mentioned above, techniques for preparing secondary batteries and solar batteries more conveniently by using a printing technique are already present. However, the secondary batteries and solar batteries, and existing primary batteries and fuel batteries contain metals, harmful substances (hazardous substances), environmental pollutants, rare elements and the like, and thus it is necessary to conduct disposition, collection and the like after separating these batteries from other waste materials. Therefore, although the production methods have become convenient, there is a problem that the disposal methods remain complex.

Therefore, the present technique mainly aims at providing a technique for producing a fuel battery in which an oxidoreductase has been fixed as a catalyst on at least one electrode of a negative electrode or a positive electrode, wherein the method for producing and method for disposing the fuel battery are easy, and design modification such as miniaturization can also be easily conducted.

### Solutions to Problems

The present inventors conducted intensive studies on a method for producing a biofuel battery and the structure thereof so as to solve the above-mentioned problem, and consequently focused on a printing technique that had not been commonsensically conducted in biofuel batteries, by changing their mindset from conventional common sense, and established a novel production technique to thereby complete the present technique.

Specifically, the present technique first provides a method for producing a fuel battery in which an oxidoreductase has been fixed as a catalyst on at least one electrode of a negative electrode or a positive electrode, including conducting at least

a step of preparing an electrode pattern, in which an electrode pattern is prepared by conducting printing by using an electrode material containing at least electroconductive particles on the surface of a bendable non-electroconductive sheet, and

a step of preparing a negative electrode and a positive electrode, in which a negative electrode and a positive electrode are made by conducting printing on the electrode pattern prepared in the step of preparing an electrode pattern, by using a predetermined oxidoreductase.

In the method for producing a fuel battery according to the present technique, the respective electrodes are formed on the non-electroconductive sheet that functions as a separator. Therefore, various forms of batteries can be constituted depending on the intended purpose by only modifying a design such as a printing pattern. Furthermore, the method for producing a fuel battery according to the present technique is a method that can produce a fuel battery even if a metal is not used at all.

In the method for producing a fuel battery according to the present technique, it is also possible to further conduct a water-repelling treatment, in which a water-repelling treatment is conducted on a part on which the negative electrode and the positive electrode are not to be formed.

Furthermore, in the method for producing a fuel battery according to the present technique, it is also possible to further conduct a step of a hydrophilization treatment, in which a hydrophilization treatment is conducted on parts on which the negative electrode and the positive electrode are to be formed on the electrode prepared in the step for preparing an electrode pattern.

In the method for producing a fuel battery according to the present technique, although the method for disposing the electrodes to be printed on the non-electroconductive sheet is not especially limited, for example, a method in which the electrode material is printed on the both surfaces of the non-electroconductive sheet, in the step of preparing an electrode pattern, and the predetermined oxidoreductase is printed on the negative electrode and positive electrode so that the electrodes face each other through the non-electroconductive sheet, in the step of preparing a negative electrode and a positive electrode, can be adopted.

In the method for producing a fuel battery according to the present technique, it is also possible to further conduct a step of folding, in which the non-electroconductive sheet having the negative electrode and the positive electrode that have been made on the surface thereof by undergoing the step of preparing an electrode pattern and the step of preparing a negative electrode and a positive electrode is folded so that the negative electrode and the positive electrode face each other through the non-electroconductive sheet.

In this case, although the folding method conducted in the step of folding is not especially limited, for example, a method in which the non-electroconductive sheet is mountain-folded in the state that the negative electrode and the positive electrode have been printed on the upper side of the sheet, or a method in which the non-electroconductive sheet is valley-folded in the state that the negative electrode and the positive electrode have been printed on the upper side of the sheet, through a non-electroconductive sheet on which the printing has not been conducted, or the like can be adopted.

In the method for producing a fuel battery according to the present technique, it is also possible to conduct a step of forming a fuel tank in which a fuel tank is formed by folding a non-electroconductive sheet on which the printing has not been conducted.

The present technique then provides a fuel battery in which an oxidoreductase has been fixed as a catalyst on at least one electrode of a negative electrode or a positive electrode, which has been formed by conducting printing on the surface of a bendable non-electroconductive sheet by using at least an electrode material containing at least electroconductive particles, and the oxidoreductase, so that the negative electrode and the positive electrode face each other through the non-electroconductive sheet.

The fuel battery according to the present technique encompasses all batteries in which electrodes have been constituted by using a printing technique on the surface of a non-electroconductive sheet, and specific constitutions thereof may include the following examples.

For example, the fuel battery can be constituted by printing the negative electrode and the positive electrode on the both surfaces of the non-electroconductive sheet so as to face each other through the non-electroconductive sheet.

Furthermore, for example, it is also possible to form by folding the non-electroconductive sheet on which the electrode material and the oxidoreductase have been printed on at least the surface, so that the negative electrode and the positive electrode face each other through the non-electroconductive sheet.

In the case when the fuel battery according to the present technique is constituted by folding the non-electroconductive sheet, the folding method can be freely designed according to the intended purpose, and for example, the fuel battery according to the present technique can be constituted by mountain-folding the non-electroconductive sheet in the state that the negative electrode and the positive electrode have been printed on the upper side of the sheet, or by valley-folding the non-electroconductive sheet in the state that the negative electrode and the positive electrode have been printed on the upper side of the sheet, through a non-electroconductive sheet on which the printing has not been conducted.

The fuel battery according to the present technique can also include a fuel tank formed by folding a non-electroconductive sheet on which the printing has not been conducted.

This fuel tank can be designed to have, for example, such a constitution that the fuel tank is folded when not in use and opened in use.

The enzyme fixed on the negative electrode in the fuel battery according to the present technique can contain at least an oxidase.

Furthermore, the enzyme fixed on the negative electrode in the fuel battery according to the present technique can also contain at least an oxidative coenzyme.

In the case when the oxidative coenzyme is incorporated in the enzyme fixed on the negative electrode, it is also possible to further incorporate a coenzyme oxidase.

Furthermore, an electron transfer mediator can be fixed besides the enzymes on at least one electrode of the negative electrode or the positive electrode of the fuel battery according to the present technique.

The fuel battery according to the present technique can be preferably used in every electronic device. Specifically, the present technique provides an electronic device using a fuel battery in which an oxidoreductase has been fixed as a catalyst on at least one electrode of a negative electrode or a positive electrode, wherein the electrode has been formed by conducting printing using at least an electrode material containing at least electroconductive particles, and the oxidoreductase, on the surface of a bendable non-electroconductive sheet.

### Effects of the Invention

By using the present technique in a biofuel battery, it is possible to attain facilitation of the method for producing and method for disposing the biofuel battery, and facilitation of the design modification such as miniaturization.

### BRIEF DESCRIPTION OF DRAWINGS

FIG. 1 is a flow diagram of the method for producing a fuel battery according to the present technique.

FIG. 2 is a schematic cross-sectional drawing that schematically shows a first exemplary embodiment of the method for producing a fuel battery according to the present technique.

FIG. 3 is a upper view planar schematic drawing that schematically shows a second exemplary embodiment of the method for producing a fuel battery according to the present technique, wherein FIG. 3 (A) is a schematic planar drawing in which the produced fuel battery is seen from the side of a negative electrode 13, and FIG. 3 (B) is a schematic planar drawing in which the produced fuel battery is seen from the side of a positive electrode 14.

FIG. 4 is an upper view planar schematic drawing that schematically shows a third exemplary embodiment of the method for producing a fuel battery according to the present technique, wherein FIG. 4 (A) is a schematic planar drawing in which the produced fuel battery is seen from the side of a negative electrode 13, and FIG. 4 (B) is a schematic planar drawing in which the produced fuel battery is seen from the side of a positive electrode 14.

FIG. 5 is an upper view planar schematic drawing that schematically shows a fourth exemplary embodiment of the method for producing a fuel battery according to the present technique, wherein FIG. 5 (A) is a schematic planar drawing in which the produced fuel battery is seen from the side of a negative electrode 13, and FIG. 5 (B) is a schematic planar drawing in which the produced fuel battery is seen from the side of a positive electrode 14.

FIG. 6 is an upper view planar schematic drawing that schematically shows a fifth exemplary embodiment of the method for producing a fuel battery according to the present technique, wherein FIG. 6 (A) is a schematic planar drawing in which the produced fuel battery is seen from the side of a negative electrode 13.

FIG. 7 is a schematic drawing that shows an example of a method for forming a fuel tank 15 in a step of forming a fuel tank VII in the method for producing a fuel battery according to the present technique.

FIG. 8 is a schematic drawing that shows an example of a method for forming a fuel tank 15, which is different from FIG. 7, in a step of forming a fuel tank VII in the method for producing a fuel battery according to the present technique.

FIG. 9 is a schematic cross-sectional drawing showing the first exemplary embodiment of the fuel battery 1 according to the present technique.

FIG. 10 is a schematic cross-sectional drawing showing the second exemplary embodiment of the fuel battery 1 according to the present technique.

FIG. 11 is a schematic cross-sectional drawing showing the third exemplary embodiment of the fuel battery 1 according to the present technique.

FIG. 12 is a schematic perspective drawing showing an example of the method for storing the fuel battery 1 according to the present technique when not in use.

### MODE FOR CARRYING OUT THE INVENTION

The preferable embodiments for carrying out the present technique will be explained below with referring to the drawings. The exemplary embodiments explained below show the examples of the typical exemplary embodiments of the present technique, and the scope of the present technique is not construed to be narrowly interpreted by these embodiments. The explanation will be made in the order shown below.

1. Method for producing fuel battery

(1) Step of preparing electrode pattern I

(2) Step of preparing negative electrode and positive electrode II

(3) Step of water-repelling treatment III

(4) Step of hydrophilization treatment IV

(5) Step of cutting V

(6) Step of folding VI

(7) Step of forming fuel tank VII

2. Fuel battery 1

(1) Non-electroconductive sheet 11

(2) Electrode material 12

(3) Negative electrode 13

(4) Positive electrode 14

(5) Fuel tank 15

(6) Negative electrode terminal 16, positive

electrode terminal 17

(7) Proton permeation film 18

(8) Fuel diffusion layer 19

(9) Gas-liquid separation film 20

3. Electronic device

### <1. Method for Producing Fuel Battery>

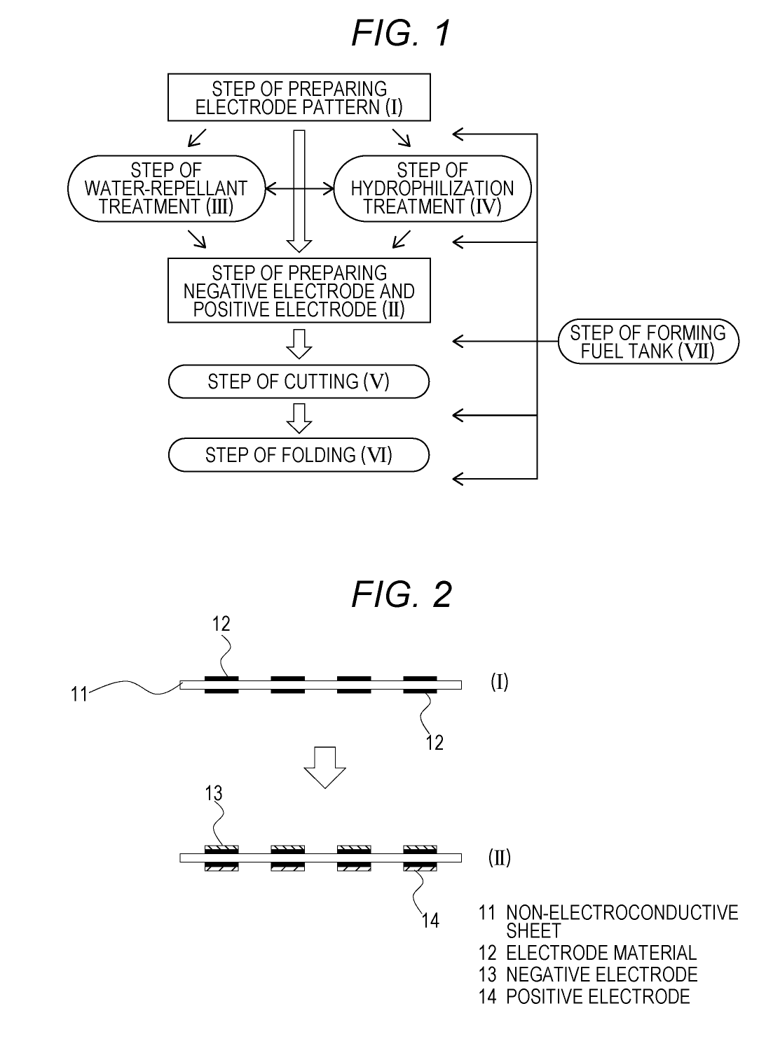

FIG. 1 is a flow diagram of the method for producing a fuel battery according to the present technique. The method for producing a fuel battery according to the present technique is a method for producing a fuel battery in which an oxidoreductase has been fixed as a catalyst on at least one electrode of a negative electrode or a positive electrode, wherein at least a step of preparing an electrode pattern I, and a step of preparing a negative electrode and a positive electrode step II are conducted. Furthermore, where necessary, a step of a water-repelling treatment III, a step of a hydrophilization treatment IV, a step of folding V, a step of forming a fuel tank VI, and the like can also be conducted. The respective steps will be explained below in detail.

(1) Step of preparing electrode pattern I

The step of preparing an electrode pattern I is a step of preparing an electrode pattern by conducting printing on the surface of a non-electroconductive sheet 11 by using an electrode material 12. As the non-electroconductive sheet used in the step of preparing an electrode pattern I, a bendable non-electroconductive sheet is adopted. Furthermore, as the electrode material 12, a material containing at least electroconductive particles is used.

As the non-electroconductive sheet 11 used in the step of preparing an electrode pattern I of the present technique, every material can be freely selected and used as long as it is a non-electroconductive bendable sheet and is also a porous sheet having liquid permeability for fuels and the like and gas permeability. For example, non-woven fabrics formed of polyamide-based fibers, polyester-based fibers, polyolefin-based fibers, cellulose-based fibers and the like, non-woven fabrics formed by subjecting those non-woven fabrics to hydrophilization treatments such as a plasma treatment and a UV ozone treatment, opaque films such as cellophane, and the like can be adopted.

As the electroconductive particles used in the step of preparing an electrode pattern I of the present technique, every particles can be freely selected and used as long as they have electroconductivity and do not deteriorate the effect of the present technique. For example, electroconductive active carbon, metal particles of gold, silver, platinum, copper, zinc, titanium, aluminum, magnesium, palladium, iridium, chromium and manganese, and the like can be adopted. Among these, it is especially preferable to use electroconductive active carbon in the present technique. This is because electroconductive active carbon is chemically stable in an aqueous solution and is inexpensive.

The electrode material 12 used in the step of preparing an electrode pattern I of the present technique only have to contain at least the electroconductive particles, but can also contain a binding agent that functions as so-called a binder, an electroconductive aid, an organic solvent and the like so as to surely conduct the printing on the non-electroconductive sheet 11.

As the binding agent that can be used in the step of preparing an electrode pattern I of the present technique, every binding agent can be freely selected and used as long as it functions as a binder and does not deteriorate the effect of the present technique. For example, polytetrafluoroethylene (PTFE), polyvinylidene fluoride (PVDF), ethylene-propylene-diene copolymer (EPDM), ethyl cellulose (EC), carbotylmethyl cellulose (CMC), hydroxypropyl cellulose, styrene-butadiene rubber (SBR), ethylene-propylene-diene rubber (EPDM), polybutadiene, fluorine rubbers, polyethylene oxide, polyvinyl pyrrolidone, polyester resins, acrylic resins, phenolic resins, epoxy resins, polyvinyl alcohol and the like can be adopted.

As the electroconductive aid that can be used in the step of preparing an electrode pattern I of the present technique, every electroconductive aid can be freely selected and used depending on the kind of the electroconductive particles as long as it does not deteriorate the effect of the present technique. For example, electroconductive carbon blacks such as Ketjen black and acetylene black, graphite and the like can be adopted. Among these, it is especially preferable to use Ketjen black in the present technique. This is because Ketjen black has high electroconductivity.

As the solvent that can be used in the step of preparing an electrode pattern I of the present technique, every solvent can be freely selected and used depending on the kinds of the electroconductive particles, the binding agent and the electroconductive aid as long as the effect of the present technique is not deteriorated. For example, terpineol, dodecanol, 2-phenoxyethanol, isopropanol, butanol, 1,2-propanediol, 1,3-butanediol, 1,4-butanediol, 1,5-pentanediol, propylene carbonate, dimethyl phthalate, diethyl phthalate, dipropyl phthalate, dioctyl phthalate, ethyl acetate, butyl acetate, butyl carbitol acetate, butyl carbitol, tetrahydrofuran, toluene, xylene, benzyl alcohol, N-methylpyrrolidone (NMP), dimethylformamide, dimethylsulfoxide, 4-methyl-2-pentanone, water and the like can be adopted. Among these, it is especially preferable to use 4-methyl-2-pentanone and water in the present technique. This is because 4-methyl-2-pentanone and water have a property that an enzyme is difficult to be inactivated also in the case when, for example, an electrode component and a catalyst component (enzyme) are mixed and printed as mentioned below. Furthermore, 4-methyl-2-pentanone and water also have an advantage that they have low boiling points and thus are easily dried.

In the step of preparing an electrode pattern I of the present technique, the printing pattern of the electrode material on the surface of the non-electroconductive sheet 11 can be freely designed depending on the intended purpose. For example, as in the first exemplary embodiment in FIG. 2, the electrode material 12 can be printed on the both surfaces of the non-electroconductive sheet so that the electrode materials face each other through the non-electroconductive sheet 11. In this case, the printing method is not especially limited, and either a method in which printing is conducted on each surface or a method in which printing is conducted on the both surfaces at once is possible in the present technique.

As mentioned above, if the electrode material 12 is printed on the both surfaces of the non-electroconductive sheet 11 so that the electrode materials 12 face each other through the non-electroconductive sheet 11, then the fuel battery according to the present technique can be produced by conducting only the step of preparing a negative electrode and a positive electrode II mentioned below, in addition to the step of preparing an electrode pattern I. Specifically, since the negative electrode 13 and the positive electrode 14 can be formed so as to face each other through the non-electroconductive sheet 11 by only a printing technique, the fuel battery according to the present technique can be produced very easily within a short period.

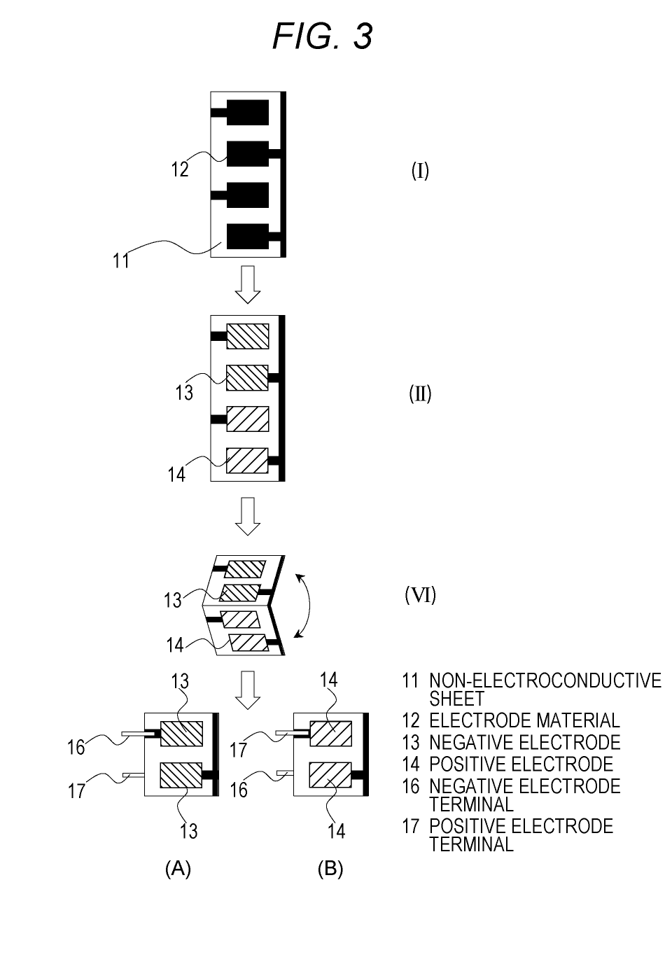

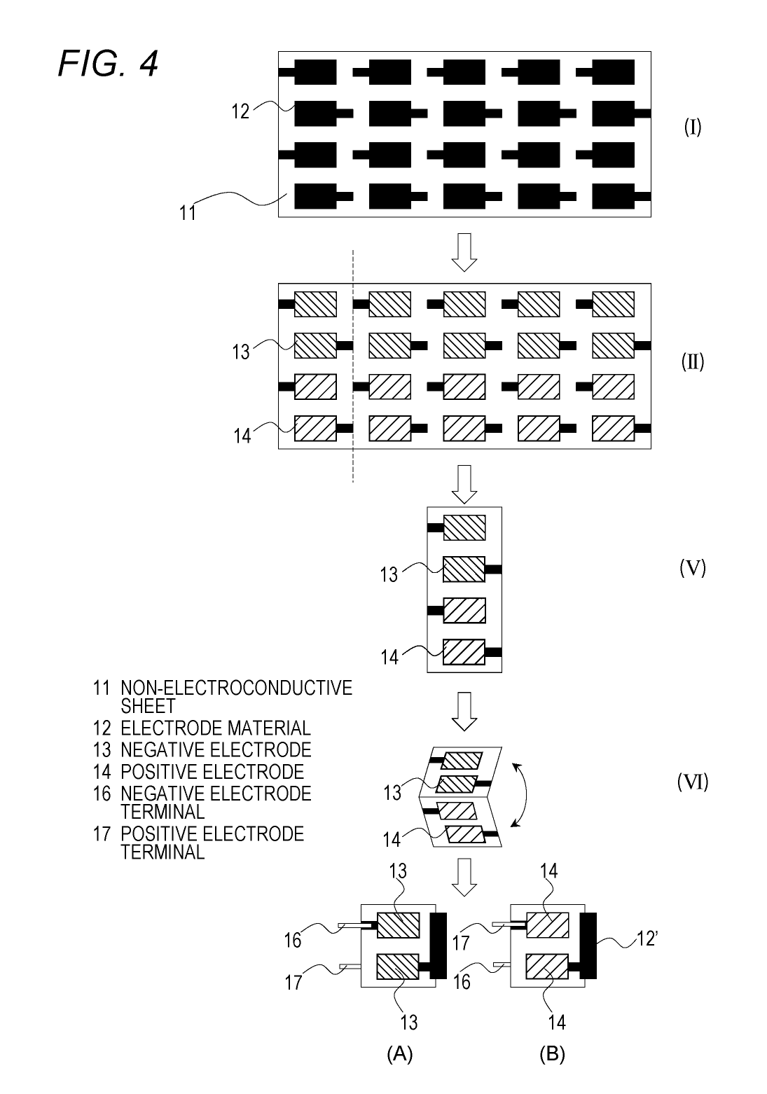

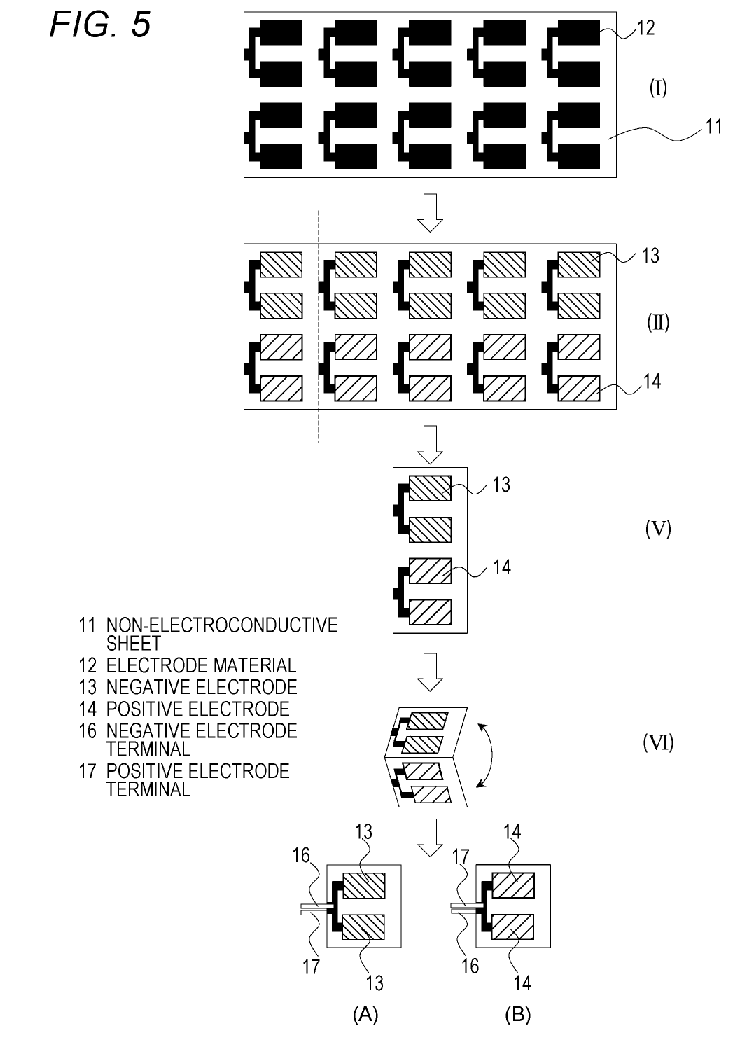

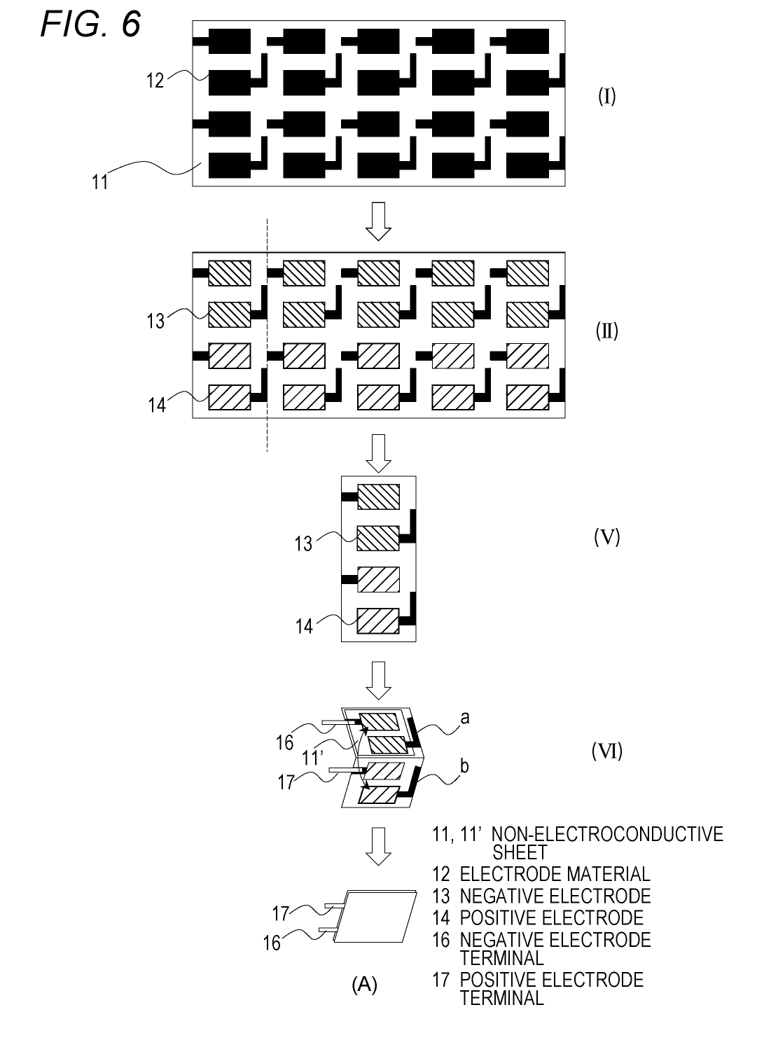

As other printing patterns, for example, printing patterns such as the second exemplary embodiment shown in FIG. 3, the third exemplary embodiment shown in FIG. 4 and the fifth exemplary embodiment shown in FIG. 6 mentioned below, and the like can be adopted for preparing batteries that are connected in series, and for example, printing patterns such as the fourth exemplary embodiment shown in FIG. 5 mentioned below, and the like can be adopted for preparing batteries that are connected in parallel.

As the printing method in the step of preparing an electrode pattern I of the present technique, an existing printing method can be freely selected and used as long as the effect of the present technique is not deteriorated. For example, screen printing, offset printing, flexography printing, gravure printing, inkjet printing, application by a dispenser and the like can be adopted.

### (2) Step of Preparing Negative Electrode and Positive Electrode II

The step of preparing a negative electrode and a positive electrode II is a step of preparing the negative electrode 13 and the positive electrode 14 by conducting printing by using a predetermined oxidoreductase on the electrode pattern prepared in the step of preparing an electrode pattern I.

As the enzyme used for preparing the negative electrode 13, one kind or two or more kinds of existing enzyme(s) can be freely selected and used depending on the kind of the fuel to be used as long as the effect of the present technique is not deteriorated. For example, in the case when a fuel containing sugars is used as a fuel, an oxidase that decomposes sugars by oxidation can be used. Examples of the oxidase may include glucose dehydrogenase, gluconate 5 dehydrogenase, gluconate 2 dehydrogenase, alcohol dehydrogenase, aldehyde reductase, aldehyde dehydrogenase, lactate dehydrogenase, hydroxypulvate reductase, glycerate dehydrogenase, formate dehydrogenase, fructose dehydrogenase, galactose dehydrogenase and the like.

Furthermore, besides the oxidase, an oxidative coenzyme and a coenzyme oxidase may be fixed on the negative electrode 13. Examples of the oxidative coenzyme may include nicotinamide adenine dinucleotide (hereinafter referred to as “NAD⁺”), nicotineamide adeninedinucleotide phosphate (hereinafter referred to as “NADP⁺”), flavin adenine dinucleotide (hereinafter referred to as “FAD⁺”), pyrrollo-quinolinequinone (hereinafter referred to as “PQQ2⁺”) and the like. Examples of the coenzyme oxidase may include diaphorase.

Furthermore, besides the oxidase and oxidative coenzyme, an electron transfer mediator may be fixed on the negative electrode 13. This is to make the transfer of the electrons generated above to the electrode smoothly. Examples of the electron transfer mediator may include 2-amino-3-carboxy-1,4-naphthoquinone (ACNQ), Vitamin K3, 2-amino-1,4-naphthoquinone (ANQ), 2-amino-3-methyl-1,4-naphthoquinone (AMNQ), 2,3-diamino-1,4-naphthoquinone, anthraquinone-1-sulfonic acid, anthraquinone-2-sulfonic acid, metal complexes of osmium (Os), ruthenium (Ru), iron (Fe), cobalt (Co) and the like, viologen compounds such as benzyl viologen, compounds having a quinone backbone, compounds having a nicotine amide structure, compounds having a riboflavin structure, compounds having a nucleotide-phosphoric acid structure, and the like.

As the enzyme used for preparing the positive electrode 14, one kind or two or more kinds of existing enzyme(s) can be freely selected and used as long as the enzyme(s) has/have an oxidase activity using oxygen as a reaction substrate and the effect of the present technique is not deteriorated. For example, laccase, bilirubin oxidase, ascorbate oxidase and the like can be used.

Furthermore, besides the enzyme(s), an electron transfer mediator may be fixed on the positive electrode 14. This is to make the receiving of the electrons that are fed from the negative electrode 13 smoothly. The kind of the electron transfer mediator that may be fixed on the positive electrode 14 is not especially limited, and can be freely selected as necessary. For example, ABTS (2,2′-azinobis(3-ethylbenzoline-6-sulfonate)), K₃[Fe(CN)₆] and the like can be used.

As the printing method in the step of preparing a negative electrode and a positive electrode II of the present technique, an existing printing method can be freely selected and used as long as the effect of the present technique is not deteriorated. For example, screen printing, offset printing, flexography printing, gravure printing, inkjet printing, application by a dispenser and the like can be adopted.

As the enzyme used in the step of preparing a negative electrode and a positive electrode II of the present technique, it is preferable to use an enzyme having heat-resistance. This is because, by using the enzyme having heat-resistance, the inactivation of the enzyme in the step of printing can be suppressed, and thus it becomes possible to conduct printing at an ordinary temperature rather than a low temperature.

Furthermore, it is preferable to select a buffer that can maintain an enzyme activity such as phosphate buffer. This is because, by selecting a buffer that can maintain an enzyme activity, the inactivation of the enzyme in the step of printing can be suppressed, and thus it becomes possible to conduct printing at an ordinary temperature rather than a low temperature.

Meanwhile, the step of preparing a negative electrode and a positive electrode II can be simultaneously conducted with the step of preparing an electrode pattern I by, for example, mixing the electrode components and catalyst component (enzyme) and conducting printing.

### (3) Step of Water-Repelling Treatment III

The step of a water-repelling treatment III is a step of conducting a water-repelling treatment on a part on which the negative electrode 13 and the positive electrode 14 are not to be formed. Although this step of a water-repelling treatment III is not an essential step in the method for producing a fuel battery according to the present technique, it is preferable to conduct so as to surely conduct power generation.

In the step of a water-repelling treatment III, the water-repelling treatment is conducted on the part on which the electrode pattern of the non-electroconductive sheet 11 has not been formed. By conducting the water-repelling treatment on the part on which the electrode pattern has not been formed in the step of preparing an electrode pattern I by this way, erroneous permeation of the fuel into the positive electrode 14 and electric leakage can be prevented, which consequently can contribute to the improvement of the performances of the produced fuel battery.

Furthermore, in the step of a water-repelling treatment III, in the case when the electrode material 12 having hydrophilicity is used in the step of preparing an electrode pattern I, the water-repelling treatment can be conducted also on the part on which the negative electrode 13 and the positive electrode 14 are not to be formed on the electrode pattern. By conducting the water-repelling treatment on the part on which the negative electrode 13 and the positive electrode 14 are not to be formed on the electrode pattern by this way, electric leakage and the like can be prevented, which consequently can contribute to the improvement of the performances of the produced fuel battery.

As the method of the water-repelling treatment conducted in the step of a water-repelling treatment III, an existing method can be freely selected and conducted as long as the effect of the present technique is not deteriorated. Examples may include a method by applying a water repellent.

As the water repellent that can be used in the present technique, one kind or two or more kinds of existing water repellent(s) can be freely selected and used as long as the effect of the present technique is not deteriorated. For example, silicone oil, fluorine coating agents in which fluorine-based polymers such as polytetrafluoroethylene (PTFE), perfluoroalkoxyalkane (PFA), perfluoroethylene propene copolymer (FEP), ethylene-tetrafluoroethylene copolymer (ETFE), ethylene-chlorotrifluoroethylene copolymer (ECTFE), polyvinylidene fluoride (PVDF), polychlorotrifluoroethylene (PCTFE) and polyvinyl fluoride (PVF) are dissolved in organic solvents can be used.

The method for applying the water repellent is also not especially limited, and an existing method can be selected and used as long as the effect of the present technique is not deteriorated. Examples may include a method in which a water repellent is applied by using a printing technique as in the step of preparing an electrode pattern I and the step of preparing a negative electrode and a positive electrode II. The printing method in this case is also not especially limited, and an existing printing method can be freely selected and conducted. For example, screen printing, offset printing, flexography printing, gravure printing, inkjet printing, application by a dispenser, and the like can be adopted.

The timing when the step of a water-repelling treatment III is not especially limited as long as it is after the step of preparing an electrode pattern I has been conducted. The step can be conducted immediately after the step of preparing an electrode pattern I, or after the step of preparing a negative electrode and a positive electrode II has been conducted. Alternatively, it is also possible to conduct after the step of a hydrophilization treatment IV, which will be mentioned below, has been conducted.

### (4) Step of Hydrophilization Treatment IV

The step of a hydrophilization treatment IV is a step in which a hydrophilization treatment is conducted on the parts on which the negative electrode 13 and the positive electrode 14 are to be formed on the electrode pattern prepared in the step of preparing an electrode pattern I. Although this step of a hydrophilization treatment IV is not an essential step in the method for producing a fuel battery according to the present technique, it is preferable to conduct this step so as to surely fix the enzyme that constitutes the negative electrode 13 and positive electrode 14 in the step of preparing a negative electrode and a positive electrode II. It is preferable to conduct this step, in the case when the electrode material 12 used in the step of preparing an electrode pattern I is hydrophobic.

As the method of the hydrophilization treatment conducted in the step of a hydrophilization treatment IV, an existing method can be selected and used as long as the effect of the present technique is not deteriorated. Examples may include a method in which a hydrophilizing agent is applied, a plasma treatment, a UV ozone treatment and the like.

In the case when the hydrophilizing agent is used, as the hydrophilizing agent that can be used in the present technique, one kind or two or more kinds of existing hydrophilizing agent(s) can be freely selected and used as long as the effect of the present technique is not deteriorated. For example, methanol and the like can be used.

The method for applying the hydrophilizing agent is also not especially limited and an existing method can be selected and used as long as the effect of the present technique is not deteriorated. Examples may include a method in which the hydrophilizing agent is applied by using a printing technique, and the like, as in the step of preparing an electrode pattern I, the step of preparing a negative electrode and a positive electrode II and the step of a hydrophobization treatment III. The printing method in this case is also not especially limited, and an existing printing method can be freely selected and conducted. For example, screen printing, offset printing, flexography printing, gravure printing, inkjet printing, application by a dispenser, and the like can be adopted.

Although it is necessary to conduct the step of a hydrophilization treatment IV after the step of preparing an electrode pattern I has been conducted and before the step of preparing a negative electrode and a positive electrode II is conducted, the order with the step of a hydrophobization treatment III is free. The step of a hydrophilization treatment IV may be conducted after the step of a hydrophobization treatment III has been conducted, or the step of a hydrophilization treatment IV can be conducted before conducting the step of a hydrophobization treatment III.

### (5) Step of Cutting V

The step of cutting V is a step of cutting the non-electroconductive sheet 11 into a necessary size or shape. Although this step of cutting V is not an essential step in the method for producing a fuel battery according to the present technique, for example, as in the third exemplary embodiment shown in FIG. 4, the fourth exemplary embodiment shown in FIG. 5 and the fifth exemplary embodiment shown in FIG. 6, which will be mentioned below, and the like, it is a step conducted in the case when plural electrodes are printed at once in the step of preparing an electrode pattern I or the step of preparing a negative electrode and a positive electrode II.

The step of cutting V can be conducted at any timing before the step of folding VI mentioned below is conducted. For example, it is also possible to conduct the respective steps after cutting the non-electroconductive sheet 11 into a desired size or shape at first. However, considering the improvement of the efficiency of the production method, it is preferable to conduct the step of cutting V after plural electrodes have been printed at once in the step of preparing an electrode pattern I and the step of preparing a negative electrode and a positive electrode II as mentioned above.

### (6) Step of Folding VI

The step of folding VI is a step of folding the non-electroconductive sheet 11 on which the negative electrode 13 and the positive electrode 14 have been formed on the surface through the step of preparing an electrode pattern I and the step of preparing a negative electrode and a positive electrode II, so that the negative electrode 13 and the positive electrode 14 face each other through the non-electroconductive sheet 11.

Although this step of folding VI is not an essential step in the method for producing a fuel battery according to the present technique, for example, except for the case when the respective electrodes are formed on the both surfaces of the non-electroconductive sheet 11 as in the first exemplary embodiment shown in the above-mentioned FIG. 2, in the case when the respective electrodes are formed on one surface of the non-electroconductive sheet 11 as in the second exemplary embodiment shown in FIG. 3, the third exemplary embodiment shown in FIG. 4, the fourth exemplary embodiment shown in FIG. 5 and the fifth exemplary embodiment FIG. 6, and the like, the negative electrode 13 and positive electrode 14 can be faced each other through the non-electroconductive sheet 11 by conducting this step of folding VI.

The specific examples of the step of folding VI will be explained below.

FIG. 3 is an upper view planar schematic drawing that schematically shows the second exemplary embodiment of the method for producing a fuel battery according to the present technique, wherein FIG. 3 (A) is a schematic planar drawing in which the produced fuel battery is seen from the side of a negative electrode 13, and FIG. 3 (B) is a schematic planar drawing in which the produced fuel battery is seen from the side of a positive electrode 14. This second exemplary embodiment is an exemplary embodiment for producing a fuel battery in which two electrodes each formed of a negative electrode 13 and a positive electrode 14 are connected in series.

In the second exemplary embodiment, the non-electroconductive sheet 11 is mountain-folded in the state that the negative electrodes 13 and the positive electrodes 14 have been printed on the upper side of the sheet to thereby allow the negative electrodes 13 and the positive electrodes 14 to face each other through the non-electroconductive sheet 11.

Meanwhile, although a negative electrode terminal 16 is connected to the negative electrode 13 of one electrode and a positive electrode terminal 17 is connected to the positive electrode 14 of the other electrode, respectively, after the step of folding VI has been conducted in the second exemplary embodiment, the negative electrode terminal 16 and positive electrode terminal 17 are not essential for the fuel battery according to the present technique, and it is possible to connect respective terminals from an electronic device to be used, or to connect commercially available terminals when the fuel battery is used.

FIG. 4 is an upper view planar schematic drawing that schematically shows the third exemplary embodiment of the method for producing a fuel battery according to the present technique, wherein FIG. 4 (A) is a schematic planar drawing in which the produced fuel battery is seen from the side of a negative electrode 13, and FIG. 4 (B) is a schematic planar drawing in which the produced fuel battery is seen from the side of a positive electrode 14. This third exemplary embodiment is an exemplary embodiment for producing a fuel battery in which two electrodes each formed of a negative electrode 13 and a positive electrode 14 are connected in series as in the above-mentioned second exemplary embodiment, but is different from the second exemplary embodiment in that the step of cutting V is conducted.

In the third exemplary embodiment, as in the above-mentioned second exemplary embodiment, the non-electroconductive sheet 11 is mountain-folded in the state that the negative electrodes 13 and the positive electrodes 14 have been printed on the upper side of the sheet to thereby allow the negative electrodes 13 and the positive electrodes 14 to face each other through the non-electroconductive sheet 11.

Meanwhile, although a negative electrode terminal 16 is connected to the negative electrode 13 of one electrode and a positive electrode terminal 17 is connected to the positive electrode 14 of the other electrode, respectively, after the step of folding VI has been conducted in the third exemplary embodiment, as in the second exemplary embodiment, the negative electrode terminal 16 and positive electrode terminal 17 are not essential for the fuel battery according to the present technique, and it is also possible to connect respective terminals from an electronic device to be used, or to use the fuel battery by connecting commercially available detachable terminals thereto when the fuel battery is used.

Furthermore, although the negative electrode 13 of one electrode and the positive electrode 14 of the other electrode are connected by using an electroconductive material 12′ after the step of folding VI has been conducted in the third exemplary embodiment, this electroconductive material 12′ is not essential for the fuel battery according to the present technique. For example, as in the above-mentioned second exemplary embodiment, it is also possible to devise the printing pattern of the electrode material 12 so that the negative electrode 13 of one electrode and the positive electrode 14 of the other electrode are connected in conducting the step of preparing an electrode pattern I, or to use the fuel battery by connecting the commercially available detachable electroconductive material 12′ when using the fuel battery.

FIG. 5 is an upper view planar schematic drawing that schematically shows the fourth exemplary embodiment of the method for producing a fuel battery according to the present technique, wherein FIG. 5 (A) is a schematic planar drawing in which the produced fuel battery is seen from the side of a negative electrode 13, and FIG. 5 (B) is a schematic planar drawing in which the produced fuel battery is seen from the side of a positive electrode 14. This fourth exemplary embodiment is an exemplary embodiment for producing a fuel battery in which two electrodes each formed of a negative electrode 13 and a positive electrode 14 are connected in parallel.

In the fourth exemplary embodiment, as in the above-mentioned second exemplary embodiment and third exemplary embodiment, the non-electroconductive sheet 11 is mountain-folded in the state that the negative electrodes 13 and the positive electrodes 14 have been printed on the upper side of the sheet to thereby allow the negative electrodes 13 and the positive electrodes 14 to face each other through the non-electroconductive sheet 11.

Meanwhile, although a negative electrode terminal 16 and a positive electrode terminal 17 are connected to the electrode pattern connected in parallel after the step of folding VI has been conducted in the fourth exemplary embodiment, the negative electrode terminal 16 and positive electrode terminal 17 are not essential for the fuel battery according to the present technique, and it is possible to connect the respective terminals from an electronic device to be used, or to use the fuel battery by connecting commercially available detachable terminals thereto when using the fuel battery.

FIG. 6 is an upper view planar schematic drawing that schematically shows the fifth exemplary embodiment of the method for producing a fuel battery according to the present technique, wherein FIG. 6 (A) is a schematic planar drawing in which the produced fuel battery is seen from the side of a negative electrode 13. This fifth exemplary embodiment is an exemplary embodiment for producing a fuel battery in which two electrodes each formed of a negative electrode 13 and a positive electrode 14 are connected in series as in the above-mentioned second exemplary embodiment and the third exemplary embodiment.

In the fifth exemplary embodiment, the non-electroconductive sheet 11 is valley-folded in the state that the negative electrodes 13 and the positive electrodes 14 have been printed on the upper side of the sheet through a non-electroconductive sheet 11′ on which printing has not been conducted to thereby allow the negative electrodes 13 and the positive electrodes 14 to face each other through the non-electroconductive sheet 11. At this time, the fuel battery in which two electrodes each formed of the negative electrode 13 and the positive electrode 14 are connected in series can be produced by folding the non-electroconductive sheet 11 so that an electrode pattern a that connects to the negative electrode 13 of one electrode and an electrode pattern b that connects to the positive electrode 14 of the other electrode are brought into contact.

In the fifth exemplary embodiment, the non-electroconductive sheet 11′ to be interposed between the negative electrode 13 and the positive electrode 14 may be identical with the non-electroconductive sheet 11 on which the negative electrodes 13 and the positive electrodes 14 have been printed, or may be a non-electroconductive sheet formed of other material.

Meanwhile, although a negative electrode terminal 16 is connected to the negative electrode 13 of one electrode and a positive electrode terminal 17 is connected to the positive electrode 14 of the other electrode, respectively, in conducting the step of folding VI in the fifth exemplary embodiment, the negative electrode terminal 16 and the positive electrode terminal 17 are not essential for the fuel battery according to the present technique. For example, it is possible to connect respective terminals from an electronic device to be used, or to use the fuel battery by connecting commercially available detachable terminals thereto when using the fuel battery.

### (7) Step of Forming Fuel Tank VII

The step of forming a fuel tank VII is a step of forming a fuel tank by folding a non-electroconductive sheet 11′ on which the printing has not been conducted. Although this step of forming a fuel tank VII is not an essential step in the method for producing a fuel battery according to the present technique, it is preferable to conduct this step so as to achieve further miniaturization of a fuel battery to be produced.

In step of forming a fuel tank VII, as the non-electroconductive sheet 11′ to be used, a non-electroconductive sheet that is identical with the non-electroconductive sheet 11 on which the negative electrode 13 and the positive electrode 14 have been printed may be used, or a non-electroconductive sheet formed of other material may be used.

Furthermore, as the non-electroconductive sheet 11′ used in the step of forming a fuel tank VII, a new non-electroconductive sheet 11′ on which the printing has not been conducted may be used, or a part on which printing has not been conducted in the step of preparing an electrode pattern I and the step of preparing a negative electrode and a positive electrode II may be used.

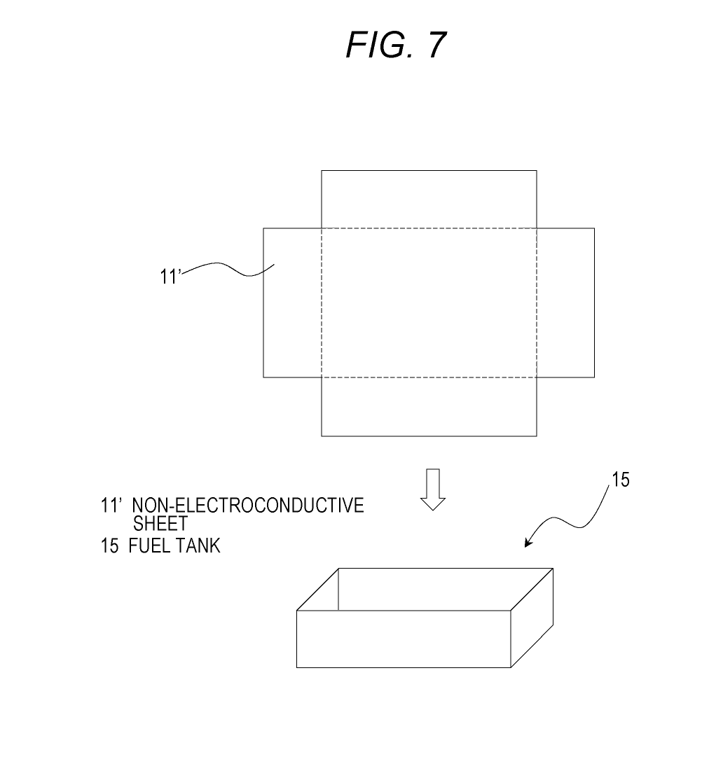

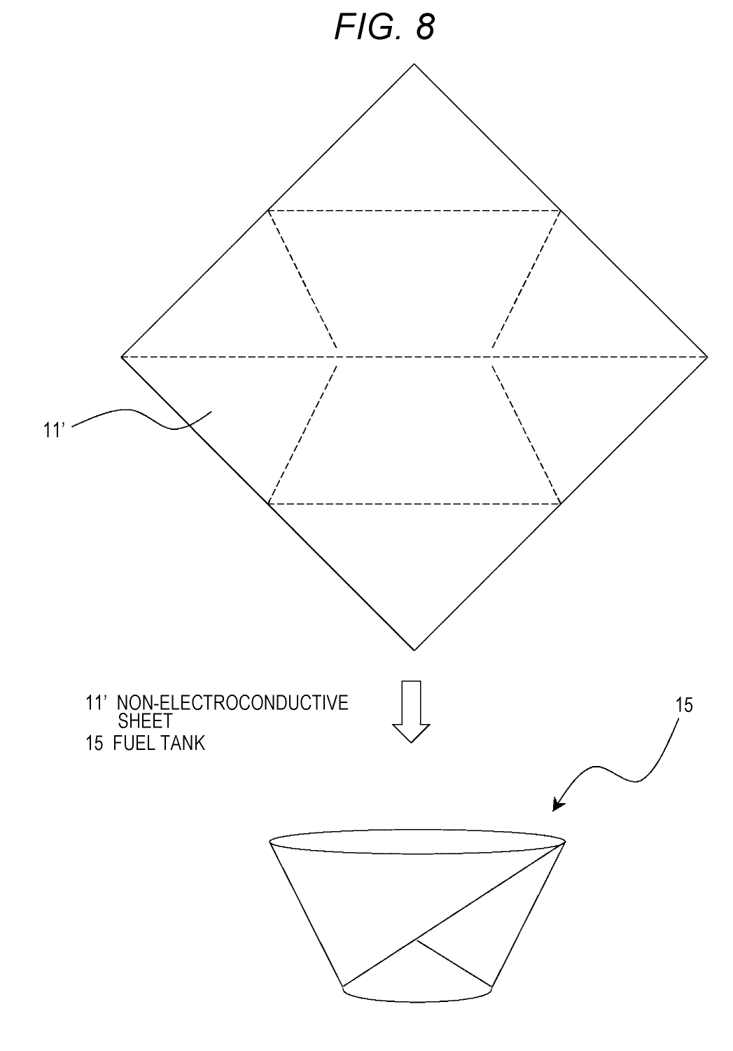

In the step of forming a fuel tank VII, the method of folding the non-electroconductive sheet 11′ is not especially limited, and the fuel tank can be freely designed as long as it can be folded in a shape that can store a fuel. For example, the fuel tank 15 can be constituted into a box-like shape as shown in FIG. 7 or into a bag-like shape as shown in FIG. 8.

### <2. Fuel Battery>

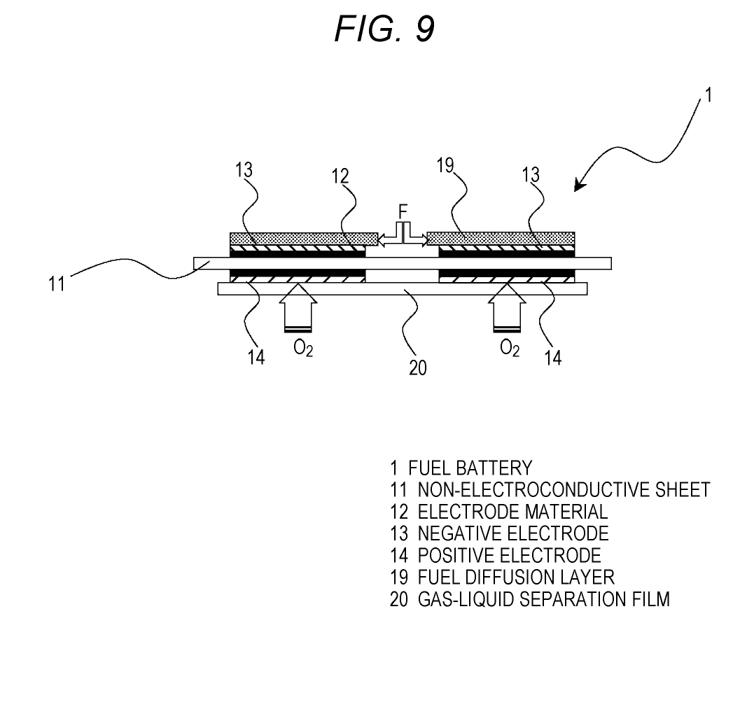

FIG. 9 is a schematic cross-sectional drawing showing the first exemplary embodiment of the fuel battery 1 according to the present technique. The fuel battery 1 according to the present technique is a fuel battery in which an oxidoreductase has been fixed as a catalyst on at least one electrode of a negative electrode or a positive electrode, and is constituted by at least a non-electroconductive sheet 11, an electrode material 12, a negative electrode 13 and a positive electrode 14. Furthermore, where necessary, the fuel battery 1 according to the present technique can further include a fuel tank 15, a negative electrode terminal 16, a positive electrode terminal 17, a proton permeation film 18, a fuel diffusion layer 19 and a gas-liquid separation film 20.

The fuel battery 1 according to the present technique is characterized in that the negative electrode 13 and the positive electrode 14 have been formed on the surface of the non-electroconductive sheet 11 by using at least the electrode material 12 containing at least electroconductive particles, and the oxidoreductase. Meanwhile, the methods for constituting the patterns of the respective electrodes, the printing method and the like are identical with those in the method for producing a fuel battery mentioned above, and thus the explanations thereon are omitted here. The respective constitutions will be respectively explained below in detail.

### (1) Non-Electroconductive Sheet 11

In the fuel battery 1 according to the present technique, the non-electroconductive sheet 11 functions as a separator that electrically separates the negative electrode 13 and positive electrode 14. As the non-electroconductive sheet 11 used in the fuel battery 1 according to the present technique, every material can be freely selected and used as long as it is a non-electroconductive bendable sheet, and the effect of the present technique is not deteriorated. Since the specific examples of the non-electroconductive sheet 11 are identical with those in the method for producing a fuel battery mentioned above, the explanations thereon are omitted here.

### (2) Electrode Material 12

The electrode material 12 used in the fuel battery 1 according to the present technique contains at least electroconductive particles. As the electroconductive particles used in the fuel battery 1 according to the present technique, every particles can be freely selected and used as long as they have electroconductivity and the effect of the present technique is not deteriorated. Since the specific examples of the electroconductive particles are identical with those in the method for producing a fuel battery mentioned above, the explanations thereon are omitted here.

Although the electrode material 12 used in the fuel battery 1 according to the present technique only has to contain at least the electroconductive particles, it is also possible to incorporate, for example, a binding agent that functions as so-called a binder, an electroconductive aid, an organic solvent and the like so as to surely conduct the printing on the non-electroconductive sheet 11. Since the specific examples of the binding agent, electroconductive aid and organic solvent are identical with those in the method for producing a fuel battery mentioned above, the explanations thereon are omitted here.

### (3) Negative Electrode 13

In the fuel battery 1 according to the present technique, the negative electrode 13 is constituted by conducting printing by using a predetermined enzyme on the electrode material 12 that has been printed on the surface of the non-electroconductive sheet 11. As the enzyme used for preparing the negative electrode 13, one kind or two or more kinds of existing oxidase(s) can be freely selected and used depending on the kind of the fuel to be used as long as the effect of the present technique is not deteriorated. Since the specific examples of the oxidase are identical with those in the method for producing a fuel battery mentioned above, the explanations thereon are omitted here.

Besides the oxidase, where necessary, an oxidative coenzyme, a coenzyme oxidase, an electron transfer mediator and the like can also be fixed on the negative electrode 13 of the fuel battery 1 according to the present technique. Since the specific examples of the oxidative coenzyme, coenzyme oxidase, electron transfer mediator and the like are identical with those in the method for producing a fuel battery mentioned above, the explanations thereon are omitted here.

### (4) Positive Electrode 14

In the fuel battery 1 according to the present technique, the positive electrode 14 has been constituted by conducting printing on the electrode material 12 that has been printed on the surface of the non-electroconductive sheet 11 by using a predetermined enzyme. As the enzyme used for preparing the positive electrode 14, one kind or two or more kinds of existing enzyme(s) can be freely selected and used as long as it is enzyme(s) having an oxidase activity using oxygen as a reaction substrate and the effect of the present technique is not deteriorated. Since the specific examples of the enzymes are identical with those in the method for producing a fuel battery mentioned above, the explanations thereon are omitted here.

Besides the enzyme, an electron transfer mediator and the like can also be fixed as necessary on the positive electrode 14 of the fuel battery 1 according to the present technique. Since the specific examples of the electron transfer mediator and the like are identical with those in the method for producing a fuel battery mentioned above, the explanations thereon are omitted here.

In the fuel battery 1 according to the present technique, the fuel battery is formed so that the negative electrode 13 and positive electrode 14 face each other through the non-electroconductive sheet 11. The formation method is not especially limited and can be freely designed as long as the negative electrode 13 and the positive electrode 14 can be formed so as to face each other through the non-electroconductive sheet 11. For example, as in the first exemplary embodiment shown in FIG. 9, the fuel battery can be formed so that the negative electrode 13 and positive electrode 14 face each other through the non-electroconductive sheet 11, by printing the electrode material 12 on the both surfaces of the non-electroconductive sheet 11 so that the electrode materials 12 face each other through the non-electroconductive sheet 11, and further printing an enzyme to be used in the negative electrode 13 on the electrode material 12 on one surface and printing an enzyme to be used in the positive electrode 14 on the electrode material 12 on the other surface.

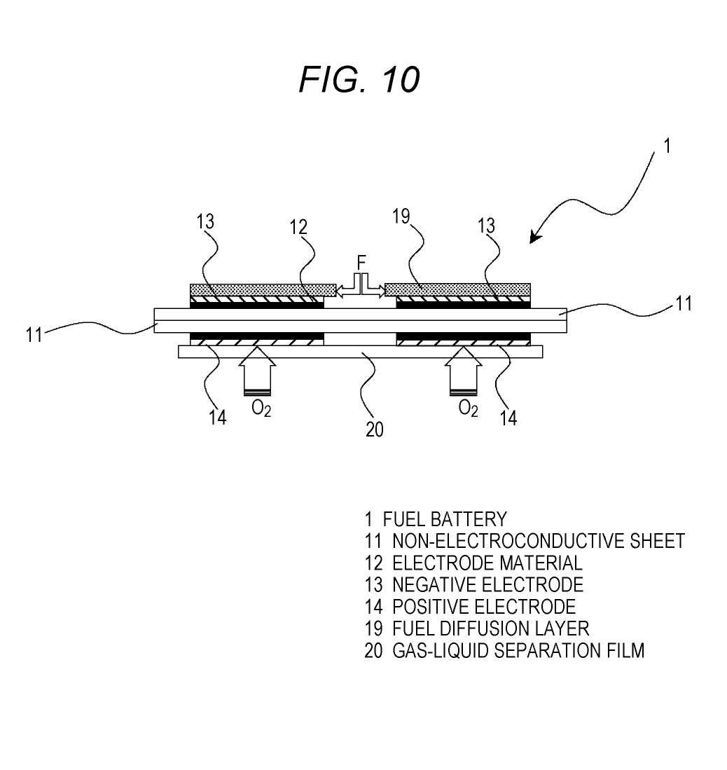

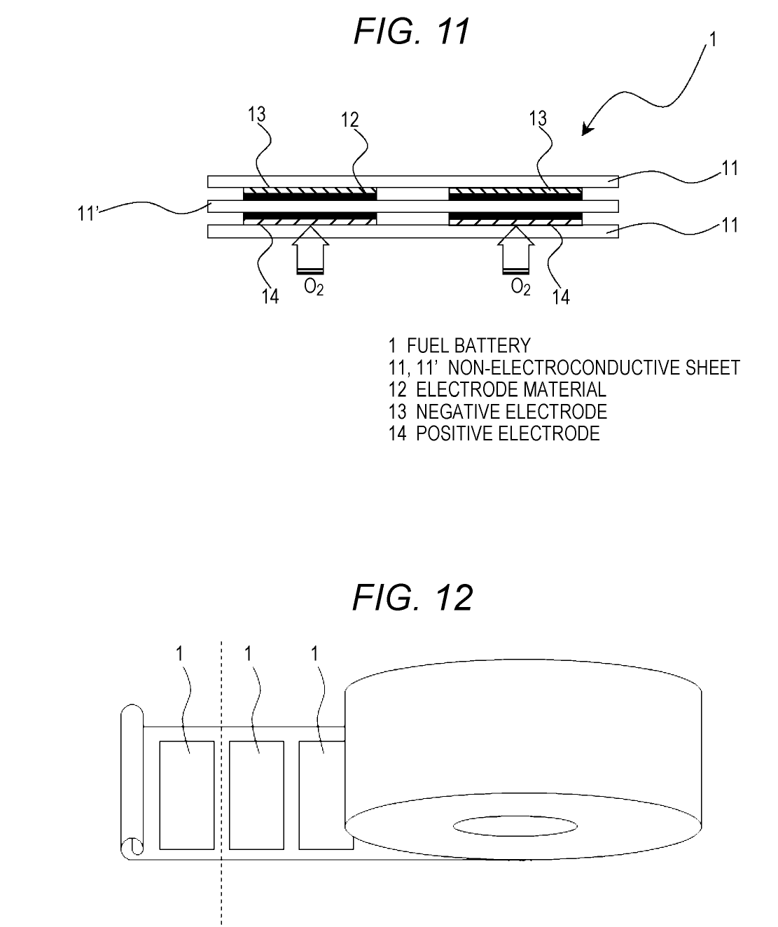

Furthermore, as another method, as in the second exemplary embodiment shown in FIG. 10 and the third exemplary embodiment shown in FIG. 11, the fuel battery can be formed by folding the non-electroconductive sheet 11 on which the electrode material 12 and the oxidoreductase have been printed at least on the surface, so that the negative electrode 13 and positive electrode 14 face each other through the non-electroconductive sheet 11.

In a more specific explanation, the second exemplary embodiment shown in FIG. 10 is an example in which the fuel battery is formed by mountain-folding the non-electroconductive sheet 11 in the state that the negative electrode 13 and the positive electrode 14 have been printed on the upper side of the sheet, so that the negative electrode 13 and the positive electrode 14 face each other through the non-electroconductive sheet 11 (see the methods for producing a fuel battery shown in FIG. 3, FIG. 4 and FIG. 5).

On the other hand, the third exemplary embodiment shown in FIG. 11 is an example in which the fuel battery is formed by valley-folding the non-electroconductive sheet 11 in the state that the negative electrode 13 and the positive electrode 14 have been printed on the upper side of the sheet, through a non-electroconductive sheet 11′ on which the printing has not been conducted, so that the negative electrode 13 and the positive electrode 14 face each other through the non-electroconductive sheet 11 (see the method for producing a fuel battery shown in FIG. 6).

In the fuel battery 1 according to the present technique, electrical energy is generated by conducting a series of reactions in which electrons are released by an oxidization reaction of a fuel on the negative electrode 13, the electrons are transferred to the positive electrode 14, and a reduction reaction proceeds on the positive electrode 14 by using the electrons and oxygen that is fed from outside.

In the fuel battery 1 according to the present technique, the numbers of the electrodes (negative electrode 13, positive electrode 14) are not especially limited. The numbers of the electrodes (negative electrode 13, positive electrode 14) can be freely designed and modified in accordance with the necessary amount of electrical power.

Furthermore, in the case when plural electrodes (negative electrode 13, positive electrode 14) are formed, the method for connecting the electrodes is also not especially limited, and either of connection in series and connection in parallel can be adopted in accordance with the required amount of electrical power. Meanwhile, since the specific examples of the connection in series are identical with the methods for producing a fuel battery shown in FIG. 3, FIG. 4 and FIG. 6 mentioned above, and the specific example of the connection in parallel is identical with the method for producing a fuel battery shown in FIG. 5, the explanations thereon are omitted here.

### (5) Fuel Tank 15

The fuel battery 1 according to the present technique can include a fuel tank 15 as necessary. This fuel tank 15 is not an essential constitution for the fuel battery 1 according to the present technique, and it is also possible to use a fuel tank having a shape that can store a commercially available fuel by attaching the fuel tank during use.

Furthermore, the fuel tank 15 may be included in the fuel battery 1 according to the present technique in advance, or it is possible to design the fuel tank into a detachable shape so that it is in a detached state when not in use and is attached when it is used.

Although the fuel tank 15 can be freely designed by using a free material as long as it has a shape that can store a fuel, the fuel tank 15 can be formed by folding a non-electroconductive sheet 11′ on which the printing has not been conducted in the present technique.

In a biofuel battery, a power generation unit can be designed to be very thin depending on the design, whereas a fuel tank always requires a large space irrespective of the presence or absence of a fuel, which has contributed to the increase in size of a biofuel battery. Although it is possible to use a thin and small fuel tank for the miniaturization of a battery, a problem that a fuel is consumed within a short period in a fuel tank having a small volume, and thus the fuel must be supplied frequently, was caused.

However, it is possible to contribute to further miniaturization of the battery by forming the fuel tank 15 by folding the non-electroconductive sheet 11′ as in the fuel battery 1 according to the present technique.

Especially, if the fuel tank 15 is designed so that the fuel tank is folded when not in use and opened when it is used, it is possible to compactly store the fuel tank when not in use and to form the fuel tank 15 having a volume depending on the intended purpose by only opening the non-electroconductive sheet 11′ when in use. By forming into such a constitution, the fuel battery 1 according to the present technique can be used as a very useful battery in cases of emergency such as disasters and acute situations.

Accordingly, the reason why the fuel tank 15 can be constituted by forming by folding the non-electroconductive sheet 11′ is that the fuel battery 1 according to the present technique can use beverages, which are ordinary and highly safe, and the like, as a fuel, as mentioned below. For example, general conventional fuel batteries use a gas, or methanol, which is highly volatile, as a fuel, and thus it was necessary to tenaciously design a fuel tank so that the fuel tank can be completely sealed, and that leakage of a hazardous fuel is prevented.

As the non-electroconductive sheet 11′ used for forming the fuel tank 15 of the fuel battery 1 according to the present technique, a non-electroconductive sheet that is identical with the non-electroconductive sheet 11 on which the negative electrode 13 and the positive electrode 14 have been printed may be used, or a non-electroconductive sheet formed of other material may be used.

Furthermore, as the non-electroconductive sheet 11′ used for forming the fuel tank 15 of the fuel battery 1 according to the present technique, a new non-electroconductive sheet 11′ on which the printing has not been conducted may be used, or the part on which the negative electrode 13 and positive electrode 14 have not been printed on the non-electroconductive sheet 11 may be used.

In the fuel tank 15 of the fuel battery 1 according to the present technique, the method for folding the non-electroconductive sheet 11′ is not especially limited, and the non-electroconductive sheet can be freely designed as long as it can be folded into a shape that can store a fuel. For example, the fuel tank 15 can be constituted into a box-like shape as shown in FIG. 7 mentioned above or into a bag-like shape as shown in FIG. 8 mentioned above.

### (6) Negative Electrode Terminal 16 and Positive Electrode Terminal 17

The fuel battery 1 according to the present technique can include a negative electrode terminal 16 and/or a positive electrode terminal 17. These negative electrode terminal 16 and positive electrode terminal 17 are not essential constitutions in the fuel battery 1 according to the present technique, and for example, it is also possible to connect respective terminals from an electronic device to be used, or to use by connecting commercially available detachable terminals when the fuel battery is used.

The negative electrode terminal 16 and positive electrode terminal 17 that can be used in the fuel battery 1 according to the present technique can be constituted by using every known material. The material is not especially limited as long as it is a material that can be electrically connected to outside, and for example, metals such as Pt, Ag, Au, Ru, Rh, Os, Nb, Mo, In, Ir, Zn, Mn, Fe, Co, Ti, V, Cr, Pd, Re, Ta, W, Zr, Ge and Hf, alloys such as alumel, brass, duralumin, bronze, nickelin, platinum rhodium, hiperco, permalloy, permendur, German silver and phosphor bronze, electroconductive polymers such as polyacetylenes, carbon materials such as graphite and carbon black, borides such as HfB2, NbB, CrB₂ and B₄C, nitrides such as TiN and ZrN, silicides such as VSi₂, NbSi₂, MoSi₂ and TaSi₂, and composite materials thereof, and the like can be used.

### (7) Proton Permeation Film 18

In the fuel battery 1 according to the present technique, it is necessary to allow the permeation of protons between the negative electrode 13 and positive electrode 14. In order to allow the permeation of protons, although it is possible to dispose a proton permeation film 18 between the negative electrode 13 and positive electrode 14, it is possible to allow the permeation of protons by using water as a medium by utilizing the liquid permeability of the non-electroconductive sheet 11 in the present technique. At this time, a buffer substance is used in combination so as to maintain the pH. This buffer substance can be used for the conduction of protons between the negative electrode 13 and positive electrode 14 by using a method in which the buffer substance is put into a fuel F in advance, a method in which the buffer substance is put into the fuel tank 15, a fuel diffusion layer 19 mentioned below or the like in advance, a method in which the non-electroconductive sheet 11 is impregnated with the buffer substance in advance, or the like.

As the buffer substance that can be used in the fuel battery 1 according to the present technique, every buffer substance can be freely selected and used as long as the effect of the present technique is not deteriorated. Examples may include dihydrogen phosphate ion (H₂PO₄⁻) formed by sodium dihydrogen phosphate (NaH₂PO₄), potassium dihydrogen phosphate (KH₂PO₄) and the like, 2-amino-2-hydroxymethyl-1,3-propanediol (abbreviation: tris), 2-(N-morpholino)ethanesulfonic acid (MES), cacodylic acid, carbonic acid (H₂CO₃), hydrogen citrate ion, N-(2-acetamido)iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviation: tricine), glycylglycine, N,N-bis(2-hydroxyethyl)glycine (abbreviation: bicine), imidazole, triazole, pyridine derivatives, bipyridine derivatives, compounds containing an imidazole ring such as imidazole derivatives (histidine, 1-methylimidazole, 2-methylimidazole, 4-methylimidazole, 2-ethylimidazole, ethyl imidazole-2-carboxylate, imidazole-2-carboxyaldehyde, imidazole-4-carboxylic acid, imidazole-4,5-dicarboxylic acid, imidazol-1-yl-acetic acid, 2-acetylbenzimidazole, 1-acetylimidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, 1-butylimidazole), and the like.

### (8) Fuel Diffusion Layer 19

The fuel battery 1 according to the present technique can include a fuel diffusion layer 19. Although this fuel diffusion layer 19 is not an essential constitution for the fuel battery 1 according to the present technique, it is preferable to include so as to surely and correctly feed a fuel to the negative electrode 13, and to allow the adjustment of the velocity and amount of the feeding of the fuel.

The constitution of the fuel diffusion layer 19 is not especially limited as long as it can diffuse a fuel to thereby feed the fuel to the negative electrode 13. For example, it can be constituted by using materials such as paper, fabrics, flow paths, polymers and hydrophilic coating materials. More specifically, it can be constituted by using materials such as fabrics of cotton, hemp, wool, silk, Tencel, cupra, rayon, polynosic, acetate, triacetate, promix, nylon, polyester, acrylic, polyurethane and the like, hydrophilized carbon fiber materials, hydrophilic polymers such as gelatin, collagen gel, casein, agar, starch, polyvinyl alcohol, polyacrylic acid, polyacrylamide, carboxymethyl cellulose, hydroxyethyl cellulose, polyvinyl pyrrolidone and dextran, and hydrophilic coating agents such as titanium oxide coating film.

### (9) Gas-Liquid Separation Film 20

The fuel battery 1 according to the present technique can also include a gas-liquid separation film 20. Although this gas-liquid separation film 20 is not an essential constitution for the fuel battery 1 according to the present technique, it is preferable to include so as to surely feed the oxygen from the air to the positive electrode 14 to thereby smoothly promote the reduction reaction in the positive electrode 14.

The constitution of the gas-liquid separation film 20 is not especially limited as long as the oxygen from the air can be fed to the positive electrode 14. For example, it is possible to constitute by using materials such as polytetrafluoroethylene (PTFE) and polyvinylidene fluoride (PVDF).

The kind of a fuel F to be fed to the fuel battery 1 according to the present technique explained above is not especially limited, and every fuel known as a fuel for a fuel battery can be fed. For example, proteins, aliphatic acids, carbohydrates or other compounds can be utilized. Among these, carbohydrates are especially more preferable from the viewpoint of their easy availability from foods, or residues, fermented products or biomass thereof, costs, general versatility, safeness and easy handling, and the like.

Furthermore, it is also possible to use a fuel that a human body can eat or drink, or contact. For example, beverages such as juices, sport drinks, sugar water and alcohols, cosmetics such as skin lotions can be used. Specifically, beverages that are ingested in everyday life, cosmetics and the like can be used as the fuel for the fuel battery 1 according to the present technique. Accordingly, if a fuel that a human body can eat or drink, or contact is used, not only safeness but also an advantage that an optional fuel can be supplied at an optional place is offered.

Since the fuel battery 1 according to the present technique can produce a battery by only using a printing technique as mentioned above, it is possible to achieve miniaturization of a battery and easy modification of a design. Especially, since the fuel battery 1 according to the present technique has a sheet-like shape, for example, as shown in FIG. 12, it is also possible to store the fuel battery by winding when not in use, and to use the fuel battery by cutting only a necessary amount for use depending on the intended amount of electrical power or shape.

Furthermore, the sizes, shapes, performances and the like have been already determined in all batteries that have been commercially available until now, and thus it was not possible for a user to design or modify the size, shape, performance and the like of a battery depending on the intended purpose. However, since the fuel battery 1 according to the present technique can also be produced by using an inkjet printer for home use or the like, a user oneself can design in accordance with the intended purpose, for example, on a personal computer, to thereby prepare the fuel battery 1 having desired size, shape and performance.

Accordingly, the fuel battery 1 according to the present technique can add an entertainment property by which a user oneself can freely prepare a battery. Furthermore, contribution to the field of education can also be expected by providing the fuel battery as an experimental study material or a kit for preparing a battery.

In addition, the fuel battery 1 according to the present technique can produce an essential constitution without using a metal. Therefore, the load on the environment is lower than that of conventional batteries, and the fuel battery can be disposed as a combustible material after use without segregation.

### <3. Electronic Device>

The fuel battery 1 according to the present technique can be preferably used in every known electronic device by utilizing the ease of the production method and disposition method thereof, the ease of design modification such as miniaturization, and the like.

The structure, function and the like of the electronic device are not especially limited as long as at least the fuel battery according to the present technique can be used, and the electronic device encompasses all devices that are electrically operated. Examples may include electronic devices such as mobile phones, mobile devices, robots, personal computers, game devices, in-car devices, domestic electronic products and industrial products, moving vehicles such as automobiles, two-wheel vehicles, aircraft, rockets and space vehicles, medical devices such as examination devices and power sources for pacemakers and power sources for intravital devices including biosensors, power generation systems such as systems that are configured to decompose raw garbage to generate electrical energy, and cogeneration systems, and the like.

In addition, the present technique can also have the following constitutions.

(1) A method for producing a fuel battery in which an oxidoreductase has been fixed as a catalyst on at least one electrode of a negative electrode or a positive electrode, including conducting at least

a step of preparing an electrode pattern, in which an electrode pattern is prepared by conducting printing by using an electrode material containing at least electroconductive particles on the surface of a bendable non-electroconductive sheet, and

a step of preparing a negative electrode and a positive electrode, in which a negative electrode and a positive electrode are made by conducting printing on the electrode pattern prepared in the step of preparing an electrode pattern, by using a predetermined oxidoreductase.

(2) The method for producing a fuel battery according to (1), including further conducting a step of a water-repelling treatment, in which a water-repelling treatment is conducted on a part on which the negative electrode and the positive electrode are not to be formed.

(3) The method for producing a fuel battery according to (1) or (2), including further conducting a step of a hydrophilization treatment, in which a hydrophilization treatment is conducted on parts on which the negative electrode and the positive electrode are to be formed on the electrode pattern prepared in the step for preparing an electrode pattern.

(4) The method for producing a fuel battery according to any of (1) to (3), wherein the electrode material is printed on the both surfaces of the non-electroconductive sheet, in the step of preparing an electrode pattern, and the predetermined oxidoreductase is printed on the electrode pattern so that the negative electrode and positive electrode face each other through the non-electroconductive sheet, in the step of preparing a negative electrode and a positive electrode.

(5) The method for producing a fuel battery according to any of (1) to (3), including further conducting a step of folding, in which the non-electroconductive sheet having the negative electrode and the positive electrode that have been made on the surface thereof by undergoing the step of preparing an electrode pattern and the step of preparing a negative electrode and a positive electrode is folded so that the negative electrode and the positive electrode face each other through the non-electroconductive sheet.

(6) The method for producing a fuel battery according to (5), wherein, in the step of folding, the non-electroconductive sheet is mountain-folded in the state that the negative electrode and the positive electrode have been printed on the upper side of the sheet.

(7) The method for producing a fuel battery according to (5), wherein, in the step of folding, the non-electroconductive sheet is valley-folded in the state that the negative electrode and the positive electrode have been printed on the upper side of the sheet, through a non-electroconductive sheet on which the printing has not been conducted.

(8) The method for producing a fuel battery according to any of (1) to (7), including further conducting a step of forming a fuel tank, in which a fuel tank is formed by folding a non-electroconductive sheet on which the printing has not been conducted.

(9) A fuel battery in which an oxidoreductase has been fixed as a catalyst on at least one electrode of a negative electrode or a positive electrode, which has been formed by conducting printing on the surface of a bendable non-electroconductive sheet by using at least an electrode material containing at least electroconductive particles, and the oxidoreductase, so that the negative electrode and the positive electrode face each other through the non-electroconductive sheet.

(10) The fuel battery according to (9), wherein the negative electrode and the positive electrode have been printed on the both surfaces of the non-electroconductive sheet so as to face each other through the non-electroconductive sheet.

(11) The fuel battery according to (9), which has been formed by folding the non-electroconductive sheet on which the electrode material and the oxidoreductase have been printed on at least the surface thereof so that the negative electrode and the positive electrode face each other through the non-electroconductive sheet.

(12) The fuel battery according to (11), wherein the non-electroconductive sheet has been mountain-folded in the state that the negative electrode and the positive electrode have been printed on the upper side of the sheet.

(13) The fuel battery according to (11), wherein the non-electroconductive sheet has been valley-folded in the state that the negative electrode and the positive electrode have been printed on the upper side of the sheet, through a non-electroconductive sheet on which the printing has not been conducted.

(14) The fuel battery according to any of (9) to (13), wherein a fuel tank has been formed by folding a non-electroconductive sheet on which the printing has not been conducted.

(15) The fuel battery according to (14), wherein the fuel tank is folded when not in use and opened in use.

(16) The fuel battery according to any of (9) to (15), wherein the enzyme fixed on the negative electrode contains at least an oxidase.

(17) The fuel battery according to any of (9) to (16), wherein the enzyme fixed on the negative electrode contains at least an oxidative coenzyme.

(18) The fuel battery according to (17), wherein the enzyme fixed on the negative electrode contains at least a coenzyme oxidase.

(19) The fuel battery according to any of (9) to (18), wherein an electron transfer mediator has been fixed on at least one electrode of the negative electrode or the positive electrode.

(20) An electronic device using a fuel battery in which an oxidoreductase has been fixed as a catalyst on at least one electrode of a negative electrode or a positive electrode, wherein the electrode has been formed by conducting printing using at least an electrode material containing at least electroconductive particles, and the oxidoreductase, on the surface of a bendable non-electroconductive sheet.

### INDUSTRIAL APPLICABILITY

The method for producing a fuel battery according to the present technique is a very convenient method, and a produced fuel battery 1 can be conveniently disposed, and the design modification thereof such as miniaturization is also easy. Therefore, the method can be attained as a power source for every electronic device.

Furthermore, if a beverage that is ingested in everyday life, a cosmetic or the like is used as a fuel, the fuel can be fed as necessary at any place. Therefore, it is possible to contribute as an electrical power source in the case when feeding of electrical power is stopped, such as the time of disaster.

In addition, if a fuel that a human body can eat or drink or touch is used as a fuel, the fuel battery can be designed as a free structure without concerning about fuel leakage and the like. Therefore, it is possible to add an entertainment property or add visual and aesthetic effects to an electronic device using the fuel battery according to the present technique.

### REFERENCE SIGNS LIST

I Step of preparing electrode pattern
II Step of preparing negative electrode and positive electrode
III Step of water-repelling treatment
IV Step of hydrophilization treatment
V Step of cutting
VI Step of folding
VII Step of forming fuel tank
1 Fuel battery
11, 11′ Non-electroconductive sheet
12 Electrode material
13 Negative electrode
14 Positive electrode
15 Fuel tank
16 Negative electrode terminal
17 Positive electrode terminal
18 Proton permeation film
19 Fuel diffusion layer
20 Gas-liquid separation film
F Fuel

1. A method for producing a fuel battery in which an oxidoreductase has been fixed as a catalyst on at least one electrode of a negative electrode or a positive electrode, comprising conducting at least
a step of preparing an electrode pattern, in which an electrode pattern is prepared by conducting printing by using an electrode material containing at least electroconductive particles on the surface of a bendable non-electroconductive sheet, and
a step of preparing a negative electrode and a positive electrode, in which a negative electrode and a positive electrode are made by conducting printing on the electrode pattern prepared in the step of preparing an electrode pattern, by using a predetermined oxidoreductase.

2. The method for producing a fuel battery according to claim 1, comprising further conducting a step of a water-repelling treatment, in which a water-repelling treatment is conducted on a part on which the negative electrode and the positive electrode are not to be formed.

3. The method for producing a fuel battery according to claim 1, comprising further conducting a step of a hydrophilization treatment, in which a hydrophilization treatment is conducted on parts on which the negative electrode and the positive electrode are to be formed on the electrode pattern prepared in the step for preparing an electrode pattern.

4. The method for producing a fuel battery according to claim 1, wherein
the electrode material is printed on the both surfaces of the non-electroconductive sheet, in the step of preparing an electrode pattern, and
the predetermined oxidoreductase is printed on the electrode pattern so that the negative electrode and positive electrode face each other through the non-electroconductive sheet, in the step of preparing a negative electrode and a positive electrode.

5. The method for producing a fuel battery according to claim 1, comprising further conducting a step of folding, in which the non-electroconductive sheet having the negative electrode and the positive electrode that have been made on the surface thereof by undergoing the step of preparing an electrode pattern and the step of preparing a negative electrode and a positive electrode is folded so that the negative electrode and the positive electrode face each other through the non-electroconductive sheet.

6. The method for producing a fuel battery according to claim 5, wherein, in the step of folding, the non-electroconductive sheet is mountain-folded in the state that the negative electrode and the positive electrode have been printed on the upper side of the sheet.

7. The method for producing a fuel battery according to claim 5, wherein, in the step of folding, the non-electroconductive sheet is valley-folded in the state that the negative electrode and the positive electrode have been printed on the upper side of the sheet, through a non-electroconductive sheet on which the printing has not been conducted.

8. The method for producing a fuel battery according to claim 1, comprising further conducting a step of forming a fuel tank, in which a fuel tank is formed by folding a non-electroconductive sheet on which the printing has not been conducted.

9. A fuel battery in which an oxidoreductase has been fixed as a catalyst on at least one electrode of a negative electrode or a positive electrode, which has been formed by conducting printing on the surface of a bendable non-electroconductive sheet by using at least an electrode material containing at least electroconductive particles, and the oxidoreductase, so that the negative electrode and the positive electrode face each other through the non-electroconductive sheet.

10. The fuel battery according to claim 9, wherein the negative electrode and the positive electrode have been printed on the both surfaces of the non-electroconductive sheet so as to face each other through the non-electroconductive sheet.

11. The fuel battery according to claim 9, which has been formed by folding the non-electroconductive sheet on which the electrode material and the oxidoreductase have been printed on at least the surface thereof so that the negative electrode and the positive electrode face each other through the non-electroconductive sheet.

12. The fuel battery according to claim 11, wherein the non-electroconductive sheet has been mountain-folded in the state that the negative electrode and the positive electrode have been printed on the upper side of the sheet.

13. The fuel battery according to claim 11, wherein the non-electroconductive sheet has been valley-folded in the state that the negative electrode and the positive electrode have been printed on the upper side of the sheet, through a non-electroconductive sheet on which the printing has not been conducted.

14. The fuel battery according to claim 9, wherein a fuel tank has been formed by folding a non-electroconductive sheet on which the printing has not been conducted.

15. The fuel battery according to claim 14, wherein the fuel tank is folded when not in use and opened in use.

16. The fuel battery according to claim 9, wherein the enzyme fixed on the negative electrode contains at least an oxidase.

17. The fuel battery according to claim 9, wherein the enzyme fixed on the negative electrode contains at least an oxidative coenzyme.

18. The fuel battery according to claim 17, wherein the enzyme fixed on the negative electrode contains at least a coenzyme oxidase.

19. The fuel battery according to claim 9, wherein an electron transfer mediator has been fixed on at least one electrode of the negative electrode or the positive electrode.

20. An electronic device using a fuel battery in which an oxidoreductase has been fixed as a catalyst on at least one electrode of a negative electrode or a positive electrode, wherein the electrode has been formed by conducting printing using at least an electrode material containing at least electroconductive particles, and the oxidoreductase, on the surface of a bendable non-electroconductive sheet.
